(19) United States
(12) Patent Application Publication
(10) Pub. No.: US 2004/0178910 A1
(43) Pub. Date: Sep. 16, 2004

(54) Patient monitoring system

(75) Inventor: Duaine Fredrick Egger, Cranbrook (CA)

Correspondence Address: BENNETT JONES LLP, 4500 Bankers Hall East, 855 - 2nd Street SW, Calgary, AB, T2P 4K7, CA

(73) Assignee: TEKARE INVESTMENTS INC.

(21) Appl. No.: 10/386,119

(22) Filed: Mar. 12, 2003

(51) Int. Cl. G08B 13/18

(52) U.S. Cl. 340/556; 340/573.4

(57) ABSTRACT

A patient monitoring system is described including a monitoring beam generating device for generating a monitoring beam along a substantially straight-line path of a selected length and a detecting means that signals the system to generate an alert signal in response to the monitoring beam being broken at least in part at a position along the length of its path.

### FIELD OF THE INVENTION

The invention relates to a patient monitoring system for monitoring the movement of a patient out of an area, such as out of a bed.

### BACKGROUND OF THE INVENTION

Statistics show a very present need for better health care options for elderly and patients needing assistance, yet who haven't the clear capacity to move freely, or who don't appreciate the risk when they move without assistance. Unassisted movement can lead to falls, which in the elderly have caused complications even leading to death. Sometimes, patients also fall inadvertently from beds or chairs, which can also create medical complications. Patients who have fallen are often left in pain, unable to move, and without ability to get help, sometimes for hours before someone can come to their aid. Sometimes, movement of patients, for example those suffering from dementia, is also of interest due to the risk they pose to other patients or staff.

Physical restraint devices are illegal in some localities unless authorized by a physician, and then can only be used for limited situations.

While some bed exit systems are available, such as bed pressure mats, they have limitations. Sometimes, care givers accidentally throw out pressure mats because of the volume of work they present, or because they are damaged and soiled, thus needing continuous replacements. In addition, false alarms, due to minor patient movements, on pressure mats render them unreliable.

While a few motion detector-based patient monitoring systems are patented, few are in wide use. Some of the patented systems require a reflector connected by wire to the emitting device, or a specific reflecting surface to be used with the device and placed a specific distance from the emitter and then set for that distance. In both cases, the emitter must be aimed precisely at the reflector and stay in absolute alignment with the reflector, or it generates an alarm. Another patented system uses passive infrared technology, which sends detection beams out in a conical, fan-like or bubble like, fashion to cover an area to be monitored. As the beam cannot be seen by the human eye, it is difficult to aim, has no defined length and offers little predictability for the operator.

### SUMMARY OF THE INVENTION

The present invention provides a patient monitoring system that generates an alert signal when a patient attempts to move out of an area, such as out of a bed. Such movement may be accidental, as by a fall or intentional but undesired, where the patient does not have the capacity to move about on his own.

The patient monitoring system does not physically restrain the patient, nor does it have to be located on the bed and therefore poses little hazard to the patient and is not troublesome for a person having to attend the patient or in the way when aides need to remake the bed.

In accordance with one aspect of the present invention, there is provided a patient monitoring system comprising a monitoring beam generating device for generating a monitoring beam along a substantially straight-line path of a selected length and a detecting means that signals the system to generate an alert signal in response to the monitoring beam being broken at least in part at a position along the length of its path.

In one embodiment, which facilitates installation and use, the patient monitoring system does not require the use of either an attached or non-attached reflector, and does not need to be specifically aimed at any item, for the sensor beam to work. In particular, in this embodiment, the monitoring beam generating device includes an output signal straight-line beam that is substantially cylindrical in area of sensitivity coming out from a portion of the device. The generated beam can be a selected length as set by the operator, the detecting means includes an input signal receiver for determining that the beam has been broken and the alert signal generating system for generating an alert signal when the determining means determines that the beam has been broken.

The straight line beam monitors along a set beam length rather than in a diffuse cone. It does not need to be aimed at a reflective device or structure and will not generate an alert signal simply by being bumped. The beam length can be set to a selected length so that the system can be used in tight areas or moved from area to area without significant resetting. Motion sensed by the system must break the generated beam, motion adjacent the beam will not create an input signal. The straight line beam can use photoelectric light, heat, sound, density, etc.

The alert signal can be generated in various ways, such as by illuminating a light and/or sounding an audible alarm at the area wherein the monitoring beam is generated and/or remotely, such as at a nurses call station, a pager, a cell phone, or illuminate a hallway light. As such, the system can include a means for connection into a remote monitoring and/or alarm generating system, for transmission of the alert signal thereto. The system can be connected to many remote monitoring systems, such as the nurse call circuit of a hospital by use of patch cords. Alternately, or in addition, the system can include a means for connection and powering of an electrical device therethrough. In one embodiment, for example, the system includes a receptacle to which power is applied when an alert signal is generated, so that for example, lights can be turned on in the event that an alert signal is generated.

In one embodiment, the system includes means for permitting connection thereto of further patient monitoring devices such as, for example, further monitoring beam generating devices and/or a nurse call button. In one such embodiment, a plurality of monitoring beam generating devices can be operated through the same system, thereby permitting monitoring of various paths about an area of interest.

Where the system includes means for permitting connection thereto of a nurse call button, a system for communicating with a nurse call circuit is included so that actuation of the call button can be communicated to the nurse call circuit through the system. Thus, both the patient monitoring system and the call button can be operated through the existing nurse call circuitry without requiring the installation of further circuitry in the nurses' station. In such an embodiment, preferably the system permits transmission of call button signals even when the patient beam generating device is not operating. Again it is useful that the connection to the nurse call circuitry be made through the use of patch cords.

It is desirable, in some embodiments to prevent remote reset of the device, should it generate an alert signal, thus requiring attendance to the locality of the patient to turn off the alert signal. Thus, in such an embodiment, the system further includes a manually operable reset button and/or a means for preventing remote reset or deactivation of alert signal generation.

### BRIEF DESCRIPTION OF THE DRAWINGS

FIGS. 1A and 1B are schematic views (FIG. 1A in plan and FIG. 1B in end view) of an application of a system according to the present invention in an area wherein a patient is to be monitored;

FIG. 2 is a block diagram showing functionality of a system in accordance with the present invention;

FIG. 3 is a block diagram showing functionality of a system in accordance with the present invention;

FIGS. 4A and 4B are perspective view of a device for performing the functionality of the present invention;

FIG. 5 is a schematic view of an area being monitored using a system of the present invention; and

FIGS. 6A and 6B are schematic views (FIG. 6A in plan and FIG. 6B in end view) of an application of a system according to the present invention in an area wherein a patient is to be monitored.

### DETAILED DESCRIPTION OF THE INVENTION

A patient monitoring system has been invented that generates an alert signal when a patient attempts to move out of an area, such as out of a chair, out of bed or through a doorway. Such movement may be accidental, as by a fall or intentional but undesired, where the patient does not have the capacity, either mentally or physically, to move about on his own. The patient monitoring system does not physically restrain the patient, nor does it have to be located on the patient or on the bed and therefore poses little hazard to the patient and is not troublesome for a person having to attend to the patient or to the bed.

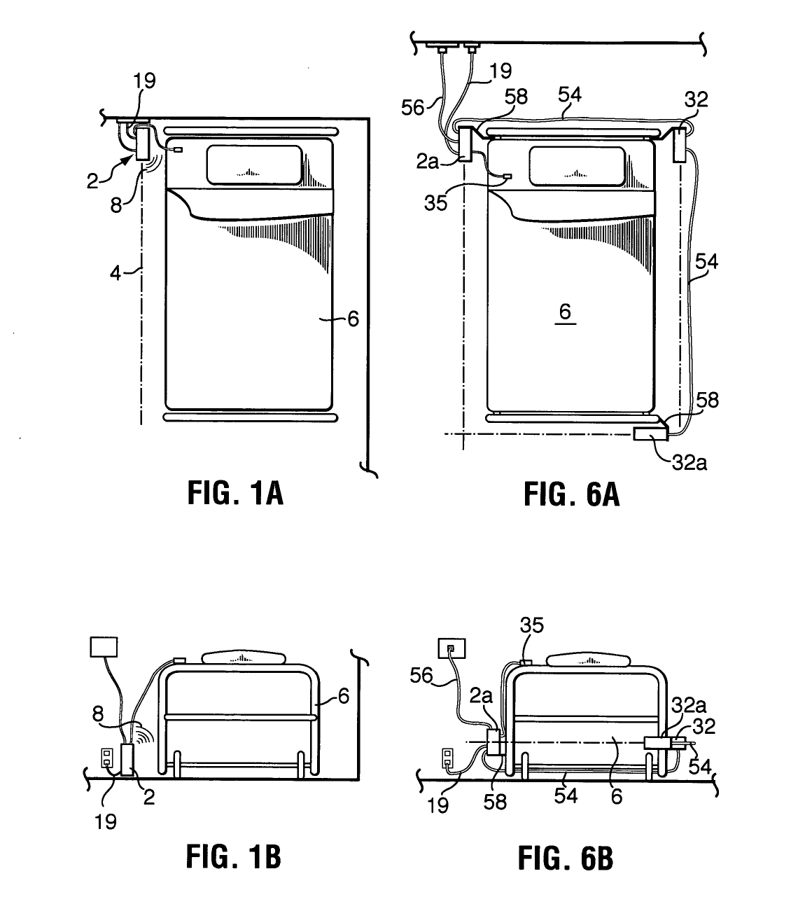

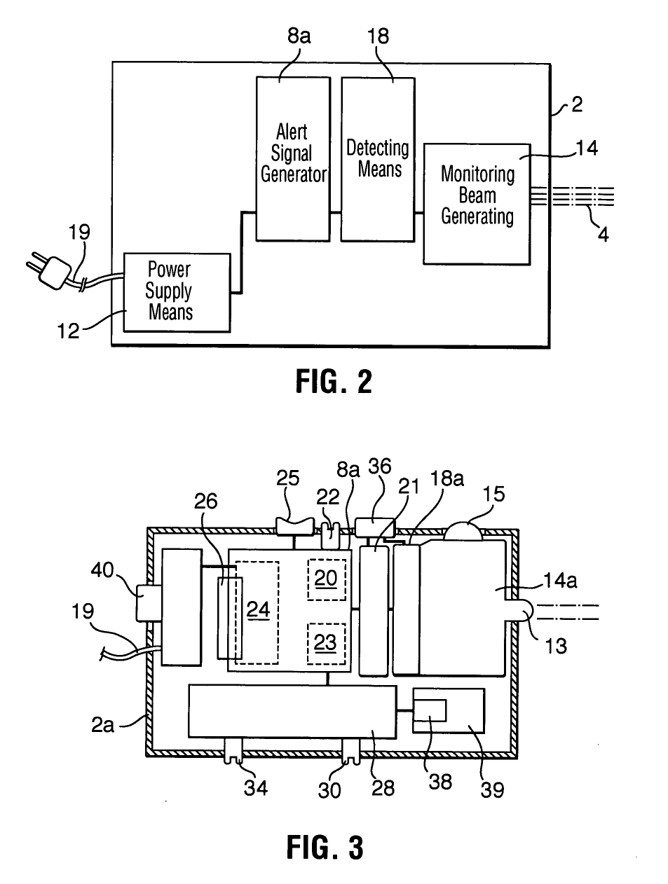

Referring to FIGS. 1 and 2, a patient monitoring system 2 according to the present invention generates a monitoring beam 4 along a path that can be positioned about an area, such as about a bed 6, wherein it is desirous of knowing when a patient has moved out of the area. Movement out of the area can be by, for example, falling out of bed or walking out of the area. The system should be positioned so that the generated beam will be broken by movement of the patient out of the area. Thus, where, for example, it is desirable to know if a patient has fallen out of bed, it may be useful position the system such that beam 4 extends along the ground at the side of the bed, as shown. Alternately, where, for example, it is desirable to know if a patient is attempting to get out of bed (before they fall), it may be useful to position the system such that the beam extends along the bed rail, or across the bed at chest height (not shown). When beam 4 is broken, an alert signal, indicated at 8 will be activated by the system to alert a care giver. If desired, a delay can be set into the system, such that where the beam is broken for a selected short time, then an alarm will not be generated.

An alarm is only generated where the beam is broken for a period of time greater than that set by the delay.

The system includes a power supply means 12 for powering the system, a monitoring beam generating device 14 for generating monitoring beam 4 along a path; an alert signal generating means 8a and a detecting means 18 that activates alert signal generating means 8a in response to the monitoring beam being broken.

Power supply 12 can be by any suitable means such as a terminal block and power cord 19 for connection to an electrical outlet. Alternately, the system can be adapted for use of a DC power supply batter, such as to permit use where there is no accessible electrical outlet.

The patient monitoring system does not require the use of a reflector with the generated beam. In the illustrated embodiment, for example, the monitoring beam generating device is a photoelectric beam generating device capable of generating a straight-line, substantially cylindrical beam and the detecting means determines that the photoelectric beam has been broken and an alert signal generating system for generating an alert signal when the detecting means determines that the photoelectric beam has been broken.

Alert signal generating means 8a can include any of various means such as, for example, an on-site audible and/or illuminated alarm (as shown as item 8 in FIG. 1) and the means for driving the alarm; communication means for transmitting a signal to activate a remote audible and/or illuminated alarm or to contact a care giver, or a combination thereof. As will be appreciated, the particular selection of the alert signal generating means can depend on the application of the system, for example, whether there is a remote monitoring station wherein an alarm can be sounded, or whether it is necessary only to alert the patient himself or a caregiver proximal to the patient.

Detecting means 18 can be any relays, circuitry or logic systems that can communicate between the monitoring beam generating device and the alert signal generating device to determine when the beam has been broken and therefore, when the alert signal should be activated.

Referring to FIG. 3, there is shown a block diagram showing functionality of another system 2a according to the present invention. The system includes a photoelectric monitoring beam generating eye 13, which is a photoelectric proximity switch with a diffused field that, as will be appreciated, does not require an attached or a non-attached reflector. Suitable eyes are, for example, a E3JU-D2M4-3™ or a E3G-ML7™ diffuse reflective sensor, available from Omron Automation, which each include both an emitter 14a and receiver 18a for a single convergence photoelectric straight beam. The eye, therefore, includes emitter 14a, operating as the monitoring beam generating device, and receiver 18a, operating as the detecting means for the system. The eye generates a beam of, for example, about a 1 inch diameter along its length, which can be adjusted in length (for example from 2 to 12 feet) by an adjustment dial 15. It does not require a reflector for operation, but monitors the beam along its length and trips when there is a change in the light beam.

Once the beam is broken, receiver 18a activates alert signal generating means 8a to send an alert signal. In the illustrated embodiment, receiver is in communication with a main control switch 21, which regulates power to the alert signal generating means 8a. Preferably, main control switch 21, once activated to power the alert signal generating means, is locked on until it is manually reset, rather than being resetable remotely. To require attendance by a caregiver to the locality of the patient to turn off the alert signal, the system can further include a manually operable reset button 36, such as for example a push button, that can be actuated manually to operate main control switch 21 to shut off the signal generation means, and therefore any alarms and to permit reset.

In the illustrated embodiment, main control switch 21 is a latch coil relay and contacts. When the beam is broken, it closes the coil and shuts the contacts to permit power to be connected to the alert signal generating means, thereby activating generation of an alert signal. As an example, a latch coil relay contains two coils. When a signal comes to the latch coil relay, a first coil is energized causing it to close, which closes a set of normally open contacts and allows a power signal through to energize a second coil, closing it. In closing, this second coil closes a plurality of sets of normally open contacts (each set of normally open contacts goes to one of the audible or visual signaling devices). When closed, the second coil is locked in this position by a mechanical or electrical lock. When the object that broke the beam is removed from the beam path, the closed set of normally open contacts in the receiver of the photoelectric proximity switch open and this stops the power signal going to the first coil in the latch coil relay. This first coil in the relay will open automatically when the signal from the photoelectric proximity switch is stopped, and it will close immediately upon receiving another signal from the photoelectric proximity switch, repeating this procedure as many times as the receiver senses that the beam has been broken. Once this first coil in the latch coil relay opens, the power signal to the first set of contacts is shut off and this set of contacts returns to its normally open state, stopping the power supplied from the patient monitoring device from reaching the second coil in the relay. This second coil remains closed due to it being latched, and the sets of normally open contacts remain locked closed as well. When the reset button 36 on the is pushed, it completes a circuit allowing a power signal, from the patient monitoring systems power supply, to energize the second coil in the latch coil relay, which opens the second coil. This permits the contacts associated with the second coil to open, which stops the power signal to the alert signal generating means.

Therefore, an alert signal will be generated continuously until the reset button of the patient monitoring system is pushed.

A suitable coil latching relay is available as item MK2 KP-UA-AC24 or item MK2 KP-UA-AC120 (Omron Automation). Of course, other means for example electrical components, circuitry or logic, can be used in place of the latch coil relay and contacts in order to prevent remote resetting of the system and these other means are to be included in the scope of this protection.

Alert signal generating means 8a includes a communication means 20 for connection of the system to, for example, a nurse call circuit for relaying an alert signal to a remote monitoring site, such as a nurses' station. Communication means 20 permits direct patching into any nurse call circuit utilizing an external jack 22 and the appropriate patching cords. Patching cords can be provided to connect between jack 22 and any form of jack that is provided for connection into the nurse call circuitry, such as for example, a ¼″, ⅛″ or telephonic wall-mounted jack. When the system of the present invention is connected to a power supply and to the nurse call circuit and is turned on and not in alarm, the nurses call circuit supplies its own signaling power through the hard wired system in the building, through wall mounted jacks, and then through the patch cord to connect to the present system through jack 22. Inside the patient monitoring system, the signal continues to a terminal block containing several sets of normally open contacts.

No changes in the patient monitoring system are necessary when the nurses call circuit uses different types of wall jack connectors or voltage. The patient monitoring system does not supply power to the nurse call circuit; instead it allows the power supplied by the nurse call circuit to run through it. When the contacts in the system are open, a power signal cannot complete its circuit through the make it through the patient monitoring system and no alarm signals at the nurses call station. When an alarm is generated, by the beam of the system being broken, power is applied to close the contacts in the system, such that the power signal from the nurse call circuit can pass through the contacts and back through the system, jack 22 and patch cord back to the nurse call circuit to generate an alert signal at the nurse call station. Once closed, the contacts in the system will preferably remain closed until the reset button 36 of the system is depressed.

Communication means 20 could also or alternately provide for communication to a dialer, either in an external system or in the system of the present invention, which dials a pager or cell phone to relay the alert signal. This permits a caregiver, for example, a family member to be away from the patient, but still be advised of an alarm situation. Where the dialer is provided as a part of the system, the dialer must be programmed or set with a contact number to be dialed and a telephone communication means (not shown) such as a cord for connection into a telephone jack will be required. In some embodiments, it may be desirable to provide for satellite communications. The dialer will only operate when power is applied to it. With reference to the above-noted discussion concerning the nurse call circuit, when the monitoring beam is broken means can be provided to close a circuit to the dialer, such that it is powered to dial a programmed contact number. If no number is programmed into the dialer, the dialer will not operate, but this will not adversely affect other alert signal generating means. When reset button 36 is depressed, this cuts power to the dialer to disconnect it. However, if the reset button is not depressed right away, the dialer will make a selected number of calls. The call signal need not be answered in order that a reset operation is permitted.

A buzzer 23 is also provided for generating an on-site alert signal. Switch 25 can be actuated to control actuation of buzzer, if desired. For example, if it is not desirable that an on-site buzzer be sounded in the event of a broken beam, the switch 25 can be turned off. A contact can be provided that closes when the beam is broken to permit power to be applied to the buzzer, should switch 25 be set to an “on” position.

The alert signal generating means further includes a means 24 for connection and powering of an electrical device therethrough. In the illustrated embodiment, for example, means 24 includes a receptacle 26 to which power is applied when an alert signal is generated, as in the above-noted means, so that for example, a room-illuminating light can be electrically connected to the system to be turned on to facilitate care in the event an alert signal is generated.

The system further includes means 28, such as outlets, receivers, jacks, communications connectors, etc. and related controls, for permitting connection thereto of further patient monitoring devices such as, for example, further monitoring beam generating devices and/or a nurse call button. In the illustrated embodiment, means 28 includes a first communication/power jack 30 for connection to a slave monitoring beam generating device (item 32 in FIG. 5).

The slave device can be operated, monitored and alert signals generated in whole or in part through system 2a. Further slave devices can be connected into the slave, as desired.

Means 28 further includes a communication jack 34 for permitting connection thereto of a nurse call button (item 35 in FIG. 5) and a system for communicating through communication means 20 with the nurse call circuit. Thus, actuation of the call button by, for example, the patient can be communicated to the nurse call circuit through the system 2a. This provides that both the patient monitoring system and the call button can be operated through the existing nurse call circuitry without requiring the installation of further circuitry to the nurses' station. In such an embodiment, preferably the system permits transmission of call button signals even when the beam generating device is not operating or the system is disconnected from its power supply, provided the system remains in communication with the nurse call circuitry, for example through jack 22. This operation is wired through the patient monitoring system, for example through its circuit board, with contacts that permit the call signal to communicate between jack 34 and jack 22, without requiring the system to be powered, as through power supply 19.

The nurse call button will work even when the patient monitoring system is not powered (i.e. turned on or connected to a power supply) provided the patient monitoring system is plugged into the nurse call circuit through a patch cord between the nurses call circuit wall jack and jack 22 since the nurse call circuit supplies its own signaling power. The nurse call button connects through a patch cord to jack 34, which is always a ¼″ type. Inside the patient monitoring system, jack 34 is connected to a contact on the terminal block, which is not associated with control switch 21. The contact associated with jack 34 is wired to the circuit from jack 22 so that signals can continue uninterrupted through the actual nurse call button to the nurse call circuitry and on to the nurses call station, when the button is depressed. There are no connections between the nurse call button and the alert signal generating devices, power control switch 21 or beam generating/monitoring device. Therefore, depression of nurse call button will not generate an alarm associated with a patient monitoring alarm.

Where the system includes a connection between a nurse call button and nurse call circuitry, an alarm generated by actuation of the nurse call button can be handled in the usual way, without involvement by the manual reset button. It may be the case that the signal generated by a broken beam situation and a call button will sound the same at the nurses' station. However, in the preferred embodiment, the nature of the signals can be differentiated by the inability to remotely turn off a system generated alert signal.

The system can also include a timer 38 for monitoring system operation. In particular, the timer can be in communication with other system means and record the times when the system is turned on and off, when an alarm signal is generated, etc. Timer 38 may be incorporated in an supervisor device 39 that permits operational parameters of the system to be recorded, so that, for example, caregiver administration or family members can review operation of the system to determine if it was turned on during a particular period, frequency of alarms, the length of time that the alarm remained on, etc. Device 39 can include, for example, a memory chip. The information contained in the device 39 can be downloaded from the device in various ways, such as by provision on the device of an information communication port (not shown). This timer and/or supervisor device can therefore, be indicative of caregiver attentiveness and record frequency of alarm situations for indicating patient activity, effectiveness of medication, risk evaluation, etc. Timer 38 and device 39 may require their own power supply such as a battery for continued operation even when the main power supply is not connected or turned on. For example, a lithium battery can be used with a circuit that permits recharging thereof every time that the system is plugged in.

The system can also include a main power switch 40, as desired, for controlling power supply through cord 19. Fuses, terminal blocks and other means can be provided to permit system protection, expansion, etc. as desired or as required.

While the system has been described using switches, etc., it is to be understood that the system control can be by other means such as by a circuit board or by programmable logic controller, microcomputer, etc.

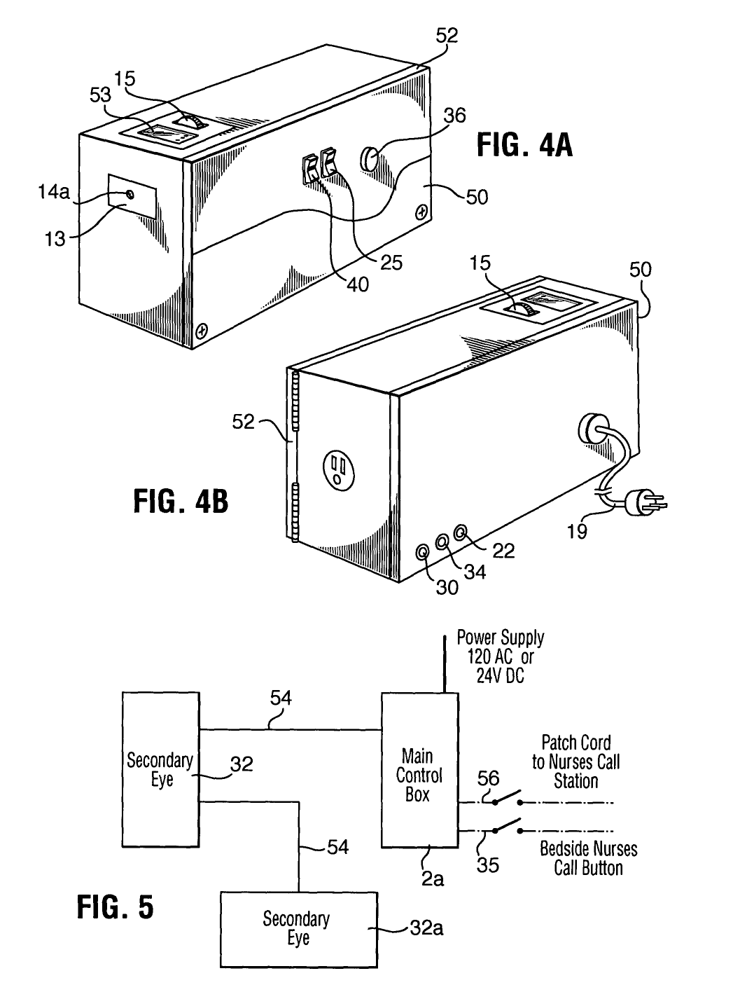

Referring to FIG. 4, a device having the functionality of the system of FIG. 3 is shown. However, it is to be understood that other forms of device can be used. The device includes a durable housing 50 in which the circuitry, relays, etc. are enclosed. A removable panel or openable door 52 is provided for access to the internal components. Door 52 can be sealed and locked or fastened shut, as desired, to prevent contamination or tampering. Eye 13, emitter 14a, adjustment dial 15 in display 53, cord 19, jack 22 from communication means 20, switch 25 controlling the audible buzzer, receptacle 26, jack 30 for connection of slave devices, jack 34 for connection of a nurse call button, reset button 36 and main power switch 40 are accessible externally.

In one aspect of the invention, with reference to FIGS. 5 and 6, the system 2a of the present invention can act as a master unit and be linked to slave devices 32, 32a by cables 54. Since slave devices 32, 32a can be simpler than the master system (i.e. containing only a monitoring beam generating device), costs can be reduced over using one unit, as in system 2a, for each monitoring requirement. For example, a plurality of slave units can be used to monitor a ward or, as shown, to monitor a plurality of paths about a critical care bed 6. In addition, only one communication 56 to the nurse call circuitry need be used for the plurality of slaves and their master system. In a preferred embodiment, as shown, a nurse call button 35 can also be connected to the master unit of the system 2a.

It is noted that each slave unit must have at least one communication jack thereon and preferably two jacks to permit incorporation into a series connection with other slave units and a master unit. Each cable must be capable of running power and signals to and from the slaves/master.

Description of Operation

The device of the present invention must be connected to a power supply such as, for example, 24V DC or 120V AC and the main power 40 switched on for operation of the beam generating and monitoring functions. The device's photoelectric proximity switch with diffused field 13, of the illustrated embodiment, receives power from the device's terminal block, which energizes the emitter 14a in the switch, to emit a straight line narrow beam of light. The receiver 18a in the photoelectric proximity switch measures the amount of light coming back into the photoelectric sensor and monitors breaks in the beam by means of a change in the light (i.e. more or less received). Any object entering the beam increases/decreases the light returning to the receiver, and that closes a set of normally open contacts in the photoelectric proximity switch, which in turn completes an electrical circuit and allows current through the photoelectric proximity switch to go to the main control switch 21.

The device can be set in various ways about an area to be monitored such as for example, on the floor as shown in FIG. 1, on brackets 58 attached to the bed, as shown in FIG. 6, or other structures such as adjacent stands or tables (not shown). The beam can be positioned along a bedside, over the top of the bed, along the floor, across a doorway, etc. As with any photoelectric beam motion sensor, the beam cannot be seen by the human eye. However, in the present invention, the use of a straight line beam facilitates set up, as the beam generated will be in a straight line and extend in a substantially cylindrical form from eye 14a, such that the operator will be able to easily determine the area of sensitivity. To aim the beam, it is useful to first deactivate the audible and visual signaling devises (i.e. turn off the audible alarm, ensure the nurses call station jack and the lamp is unplugged, etc.) so that false alarms are not generated.

The photoelectric proximity switch eye 13 is installed in the housing with an emitter 14a portion exposed. The device is aimed directly along its long axis through the emitter portion of the eye like aiming a gun, by the operator considering the axis or by sighting along the top and out along a short path.

Since the distance of the beam is short and controllable, the operator can easily see if anything, such as a motionless object or a person, obstructs the pathway, and reposition the patient monitoring device until they think the line of sight is clear. Once this is done, the operator turns the patient monitoring device on by pressing main power switch 40. An indicator light on display 53 located on the photoelectric proximity switch will show green, if the beam is unobstructed and ready for use, or amber, when something is obstructing the photoelectric beam.

If the indicator on the photoelectric proximity switch shows amber, the operator must adjust the patient monitoring device until the light turns to green. If the indicator light on the photoelectric proximity switch shows green, then the system is ready for use and the operator must press the reset button on the patient monitoring device, to prepare the device for operation. The operator can then activate one or more of the audible and visual signaling devices by, for example, turning on the audible alarm switch 25, connecting the nurses station cord between the patient monitoring device jack 22 and the nurses call circuit, and plugging a lamp into the electrical receptacle 26 on the patient monitoring device. As will be appreciated, only those alert signal generating means that are connected and operable will be capable of generating a signal, but overall operation is not adversely affected should it be decided that a particular alert generating device not be connected or operable, unless of course no alert signal generating means are connected and/or operable.

The photoelectric sensor must be adjusted using the adjustment dial to be set from 2′ to 12′ depending on the length of the opening/area to be monitored. In another embodiment, the device can be set to allows the beam to monitor only along a path beginning a selected distance, for example, three feet, from the eye. This setting allows people to walk between the emitter and the monitored path without setting off an alarm.

As many slave units as are needed can be connected together in series to the main device in order to monitor multiple sides of a bed, or to monitor other beds/areas. To operate the slaves from a master device, cables are connected between each of the master unit and the slaves in series. Daisy-chaining in this way can be achieved through 5-pin cable jack 30, the first of which is connected to the master device's terminal block. Each slave unit contains a photoelectric proximity switch with diffused field. In this configuration, each slave patient monitoring device receives power, for example any DC or AC current, from the master device, which energizes each of the slave photoelectric proximity switch emitters, which in turn sends out a substantially straight line narrow beam of light. The length of each beam is selected by manually setting a ‘distance set’ on each slave photoelectric proximity switch. Generally, the beam can be set to 8 to 12 feet in length without needing a reflector.

The receivers in the master and slave photoelectric proximity switches all measure the amount of light coming back into their photoelectric sensor, by means of a change in the light received. Any object entering any beam increases or decreases the light returning to that beam's receiver. Where the beam is broken in a slave unit, a switch on the unit communicates this to the master unit, as by closing contacts in the slave which complete an electrical circuit going back through the Spin cable connection to the master and allows current through the master's photoelectric proximity switch to activate the main control switch to operate any alert signal generating means connected and operable in the master unit.

As noted, where communication is required with a nurses call station, a patch cord is plugged between either one of the jacks 30, 34 on the device and the nurses call circuit. There are no changes necessary inside the patient monitoring device regardless of the parameters, for example, type of cord connectors or voltage, of the nurses call circuit. All variations can be accommodated by selection of an appropriate patch cord. As noted, an alert signal generated by the device due to a broken beam, cannot be turned off remotely from the nurses call station due to the manual reset requirement of the main control switch.

Note, that the device can also be employed where there is no nurses call circuit, since the device can create an on-site alarm, such as an audible alarm through buzzer 23, and/or it can turn on room-illuminating lights, connected to means 24, when tripped. Of course, if an audible signal at the device is required, then the audible alarm switch 25 must be turned on and if it is desired that a lamp be illuminated through receptacle 26 in the event of an alert signal, then a lamp must be plugged in to the receptacle and turned on.

A nurse call button can be installed in the jack 34. The nurse call button also works when the device is turned off or unplugged, so long as the device remains connected to the nurse call circuit.

If a caregiver needs to attend to a patient, they may simply turn off the power switch 40 while they work and turn it on when have finished. If the device is accidentally set-off by an attendant breaking the beam or moving the box dramatically (after being armed), the reset button 36 can be pressed.

If the device is not connected to a nurses' station, and a signal comes through the device from a nurse call button, then that signal can be shut off, as local procedures allow. However, if an alarm is generated at the nurses' station by a patient breaking a monitoring beam of a master or slave device, an attendant must attend to the device to turn the alarm off or to reset the alarm through button 36.

This signal cannot be shut off except by the attendant going to the device to turn the alarm off, or reset the alarm. In particular, in a device including a latch coil relay and a photoelectric proximity switch, each receiver in the master and slave(s) photoelectric proximity switches measures the amount of light coming back into the receiver. Any object entering any master or slave beam increases/decreases the light returning to the receiver in that photoelectric proximity switch and that closes a set of normally open contacts in that photoelectric proximity switch, which in turn completes an electrical circuit and allows current to go through the latch coil relay in the device. This signal energizes the first coil of the latch coil relay, causing it to close. This, in turn, closes a set of normally open contacts, which in turn allows a power signal through to energize the second coil, closing it. In closing, this second coil mechanically closes four sets of normally open contacts (i.e. each set of normally open contacts goes to one of the four audible or visual signaling devices). Once this second coil closes, it will not open again, even when the first coil opens due to there being no more alarm. This second coil is designed with a mechanical latch controlled by a set of normally open contacts to keep it closed and to ensure the power signal continues to the signaling devices including the nurses call station, the electrical receptacle, the audible alarm and the dialer. The second coil will remain in this mechanically latched closed position until the reset button 36 is pushed on the patient monitoring device. This is to ensure that no-one can override the alarm signal at the Nurses station, or by a remote feature without going to the room (location of the alarm) to view the reason for the alarm.

When the reset button on the patient monitoring device is pushed, a power signal from the terminal block is allowed through the reset button to close a set of normally open contacts which allows a power signal through to the second coil in the latch coil relay. This energizes it which opens the second coil and, in turn, opens the contact for the four signaling devices to cut power to them and shut them off.

Of course, other means for example electrical components, circuitry or logic, can be used in place of the latch coil relay and contacts in order to prevent remote resetting of the system and these other means are to be included in the scope of this protection.

Timer 38 and supervisor device 39 operate, as by provision of their own batteries, even while the system is not powered. From time to time, supervisors such as caregiver administration or family members can review operation of the system to determine if it was turned on during a particular period, frequency of alarms, the length of time that the alarm remained on, by connecting to the system and downloading the information recorded therein. This timer and/or supervisor device can therefore, be indicative of caregiver attentiveness and record frequency of alarm situations for indicating patient activity, effectiveness of medication, risk evaluation, etc.

It will be apparent that many other changes may be made to the illustrative embodiments, while falling within the scope of the invention and it is intended that all such changes be covered by the claims appended hereto.

1. A patient monitoring system comprising a monitoring beam generating device for generating a monitoring beam along a substantially straight-line path of a selected length and a detecting means that signals the system to generate an alert signal in response to the monitoring beam being broken at least in part at a position along the length of its path.

2. The patient monitoring system of claim 1 wherein the monitoring beam is non-reflective.

3. The patient monitoring system of claim 1 wherein the monitoring beam creates a substantially cylindrical area of sensitivity.

4. The patient monitoring system of claim 1 wherein the monitoring beam is selected from the group consisting of light, heat, sound or density.

5. The patient monitoring system of claim 1 wherein the alert signal includes the illumination of a light.

6. The patient monitoring system of claim 1 wherein the alert signal includes the sounding of an audible alarm.

7. The patient monitoring system of claim 1 further comprising a dialer and wherein the alert signal is generated by operating the dialer to contact a caregiver by telephone.

8. The patient monitoring system of claim 1 further comprising means for connection into a nurse call circuit for transmission of the alert signal to a nurse station.

9. The patient monitoring system of claim 8 further comprising wherein the means for connection includes a jack and a patch cord.

10. The patient monitoring system of claim 9 further comprising wherein the jack is fixed without consideration to the nurse call circuit parameters and the patch cord is selected to correspond with the parameters of the nurse call circuit.

11. The patient monitoring system of claim 1 further comprising a means for connection and powering of an electrical device therethrough upon generation of the alert signal.

12. The patient monitoring system of claim 11 wherein the means for connection and powering of an electrical device therethrough upon generation of the alert signal includes a receptacle to which power is applied when the alert signal is generated.

13. The patient monitoring system of claim 1 further comprising means for permitting connection thereto of a secondary patient monitoring device.

14. The patient monitoring system of claim 13 wherein the secondary patient monitoring device is a nurse call button for generating an alarm at a nurse station and the system further comprises means for connection into a nurse call circuit, for transmission of the alert signal and the alarm to a nurse station.

15. The patient monitoring system of claim 13 wherein the system permits transmission of call button-generated alarms to the nurses station even when the system is not powered.

16. The patient monitoring system of claim 13 wherein the secondary patient monitoring device is a slave monitoring beam generating device.

17. The patient monitoring system of claim 16 wherein the slave monitoring beam generating device includes a monitoring beam generating means for generating a monitoring beam and a detecting means that signals the patient monitoring system to generate an alert signal in response to the slave's monitoring beam being broken at least in part at a position along the length of its path.

18. The patient monitoring system of claim 16 wherein the slave monitoring beam generating device is a first such device and a second such device is further providing and wherein the first device is connected to the patient monitoring system and the second device is connected to the first device and the second device obtains power from and is capable of communicating with the patient monitoring system.

19. The patient monitoring system of claim 1 including means preventing remote reset of the system, requiring attendance to the locality of the system to turn off the alert signal.

20. The patient monitoring system of claim 1 further comprising a manually operable reset button and a circuit for preventing remote reset of the detecting means.

21. The patient monitoring system of claim 1 further comprising a timer for recording the time of actuation of selected means within the system.

22. The patient monitoring system of claim 1 further comprising a supervisor device for recording operational parameters of the system.

23. A method for monitoring a patient's movement, the method comprising:
providing a patient monitoring device comprising a monitoring beam generating device for generating a monitoring beam along a substantially straight-line path of a selected length and a detecting means that signals the patient monitoring device to generate an alert signal in response to the monitoring beam being broken at least in part at a position along the length of its path, positioning the patient monitoring device to generate the beam along a path which is crossed by patient movement and monitoring the device for generation of an alert signal.

24. The method of claim 23 wherein the patient monitoring device includes a long axis and the monitoring beam is emitted in a substantially straight line parallel with the long axis and the method further comprising aiming the beam by sighting along the long axis and selecting the length of the beam.

25. The method of claim 23 wherein the alert signal is communicated to a nurse station through a nurse call circuit to which the device is in communication.

26. The method of claim 23 further comprising recording operational parameters of the device.

27. The method of claim 23 further comprising providing further slave patient monitoring devices and placing them in communication with the patient monitoring device and positioning the slave patient monitoring devices to monitor patient movement in other areas.
